(19) United States
(12) Patent Application Publication
(10) Pub. No.: US 2008/0103838 A1
(43) Pub. Date: May 1, 2008

(54) Insurance estimating system

(76) Inventors: Beth Taylor, Livermore, CA (US); Denis Barrette, St-Hubert (CA); Richard Lavoie, Saint-Eustache (CA); Michel Barrette, Lachenaie (CA); Frederic D. Bersot, Oakland, CA (US)

Correspondence Address: IRELL & MANELLA LLP, 840 NEWPORT CENTER DRIVE, SUITE 400, NEWPORT BEACH, CA, 92660, US

(21) Appl. No.: 11/823,371

(22) Filed: Jun. 26, 2007

Related U.S. Application Data
(60) Provisional application No. 60/816,748, filed on Jun. 26, 2006.

(51) Int. Cl. G06Q 40/00

(52) U.S. Cl. 705/4

(57) ABSTRACT

A method and system for reviewing and managing insurance estimates and images. The system includes electronic storage system that can track changes to the insurance estimates, a review station that allows a reviewer to review the estimates and potentially make changes to the estimates. Optionally the system and method also comprise reinspection of the insured property and the ability for the reinspector to make changes to the insurance estimate.

### CROSS-REFERENCE TO RELATED APPLICATION

This application claims priority to U.S. Provisional Patent Application No. 60/816,748, filed on Jun. 26, 2006.

### BACKGROUND OF THE INVENTION

1. Field of the Invention

The subject matter disclosed generally relates to a method and system for reviewing insurance estimates.

2. Background Information

Insurance allows consumers to mitigate the risk of loss to their property. When that property is damaged the owner may file a claim with an insurance company. Commonly the insurance company will inspect the property to determine the amount of damage and the costs required to replace the property. The owner of the property or the property repair facility may receive a payment equal to the estimated cost of the repair. If the repair costs exceed the value of the property, or a percentage of the property value, the adjuster may “total” the property. The owner may then receive a check equal to the value of the property.

The repair costs and other information may be entered by the adjuster or repair shop into an estimate report. The adjuster or repair shop may be referred to as the estimator. After inspection of the property the estimator sends the resulting estimate report to the insurance home office for approval. To improve the efficiency of the claims process there have been developed computer systems and accompanying software that automate the estimate process. For example, software exists that allows an estimator to enter estimate data with a client side software platform that is loaded into the computer of a client such as a repair shop. The client based software interfaces with a home office computer system. The home office computer system contains large databases that store claims records used to process insurance claims.

Some insurance companies may also have a process for reviewing the estimates made by the estimators. This review process may also involve reinspectors who physically examine the property. To locate an available reinspector the reviewer may need to make several phone calls or look in separate directories. In general, during the review and/or reexamination process neither the reviewer nor the reinspector can make changes to the estimate. Rather, these individuals may only create supplements to a completed estimate. Thus the estimate may be accessed by many individuals and perhaps even payment may be made before a review has been completed.

During the process of reviewing the claims, it is may be necessary for the reviewer to communicate with the other parties such as the reinspector. Conventionally this may be done through telephone calls, faxes, separate-electronic mail, or other means. This is disadvantageous in that these means are sometimes slow and unreliable. Also, these methods do not allow for communications regarding a particular estimate to be tracked and recorded for history in one place.

### BRIEF SUMMARY OF THE INVENTION

A method and system for reviewing and reinspecting insurance estimates. The system includes electronic storage system that can track changes to the insurance estimates, a review station that allows a reviewer to review the estimates and make changes to the estimates.

### BRIEF DESCRIPTION OF THE DRAWINGS

FIG. 1 is a diagram of an embodiment of a system for reviewing insurance estimates;

FIG. 2 is a flow chart showing a process for reviewing insurance estimates;

FIG. 3 is a graphical user interface that may be used by a reviewer to select different options for reviewing an insurance estimate and images;

FIG. 4 is a graphical user interface that may be used to review insurance estimates;

FIG. 5 is a graphical user interface that may be used to enter, change, and/or select damaged parts for insured property

FIG. 6 is a graphical user interface that may be used to assist a reviewer in tracking changes made to an insurance estimate.

FIG. 7 is a flow chart illustrating an embodiment of a method for reinspection of insurance estimates;

FIG. 8 is a graphical user interface that may be used to assist a reviewer in selecting available reinspectors;

FIG. 9 is a flow chart illustrating an embodiment of a method that allows a reviewer to save his changes as complete and approved;

FIG. 10 is a flow chart illustrating an embodiment of a method that allows a reviewer to save his changes and send them for agreement

FIG. 11 is a schematic of an embodiment of a station used in the system.

### DETAILED DESCRIPTION

Disclosed is a system for reviewing and/or reinspecting insurance estimates.

Overview of Review System

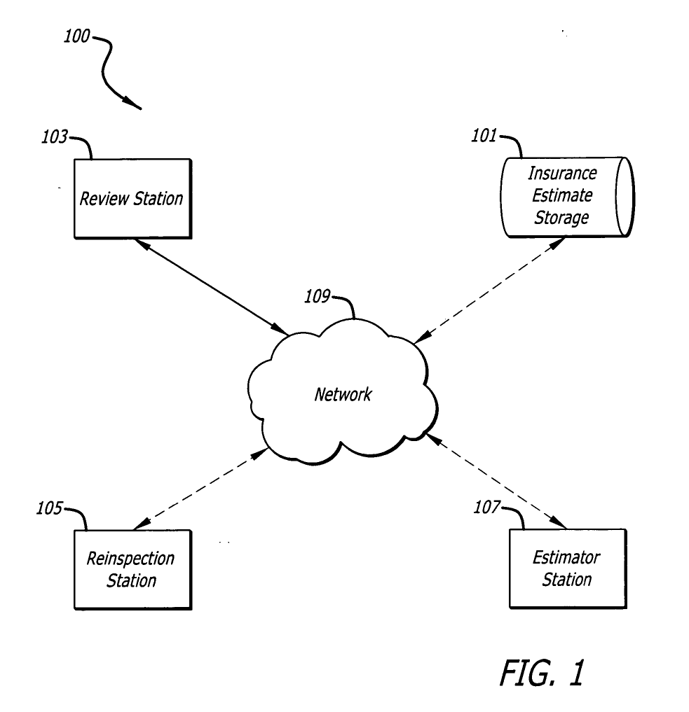

FIG. 1 is a block diagram of an exemplary implementation showing many of the elements of the insurance reviewing system 100. Some of these elements are optional and need not be present in all embodiments. Information on insured property can be kept as insurance files in the insurance estimate storage 101. The insurance file contains at least one insurance estimate but it may also contain other estimates along with other data.

A review station 103 allows a reviewer to review the insurance estimates. The review station 103 provides the reviewer with several options for processing an insurance estimate such as approving the estimate, disapproving the estimate, or making changes to the estimate.

A reinspection station 105 allows a reinspector to review the insurance estimates based on reinspection of the insured property. The reinspection station 105 may also provide the reinspector with several options for processing an insurance estimate such as approving the estimate, disapproving the estimate, or making changes to the estimate.

A estimator station 107 allows an estimator to submit insurance estimates into the system. The estimator station 107 may also provide the estimator with notices related to the insurance estimates and/or provide the estimator with options for reviewing the estimate such as agreeing with the review of the estimate or supplementing the estimate. The estimator may be an insurance adjustor or a repair shop.

The insurance estimate storage 101, review station 103, reinspection station 105, and estimator station 107 may be linked together using an electronic communications network 109. The electronic communication network 109 may be a wide area network (WAN) such as the Internet. Accordingly, communication may be transmitted through the network 109 in TCP/IP format.

Overview of Review Process

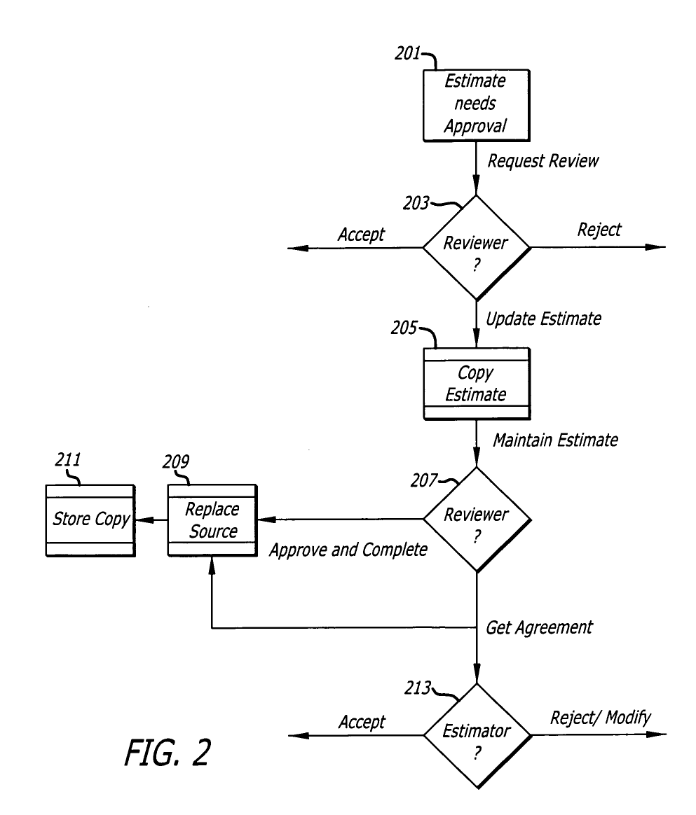

FIG. 2 is an example of a process for reviewing an insurance estimate. At the start of the process in step 201, an insurance estimate needs approval and a review is requested. The status of the insurance file is changed to indicate that it is pending approval. Once the insurance file is so marked, it is considered to be in progress and the only parties that can access the file are those described in the process below. For example, these may include the reviewer and the estimator.

In step 203, the reviewer may use the reviewing station 103 to retrieve an insurance file from the insurance estimate storage 101. For example, the insurance file may be displayed on the review station 103. Next, in decision block 203 the reviewer has options, some of which are described below. These options may, for example, be displayed graphically on a review station 103.

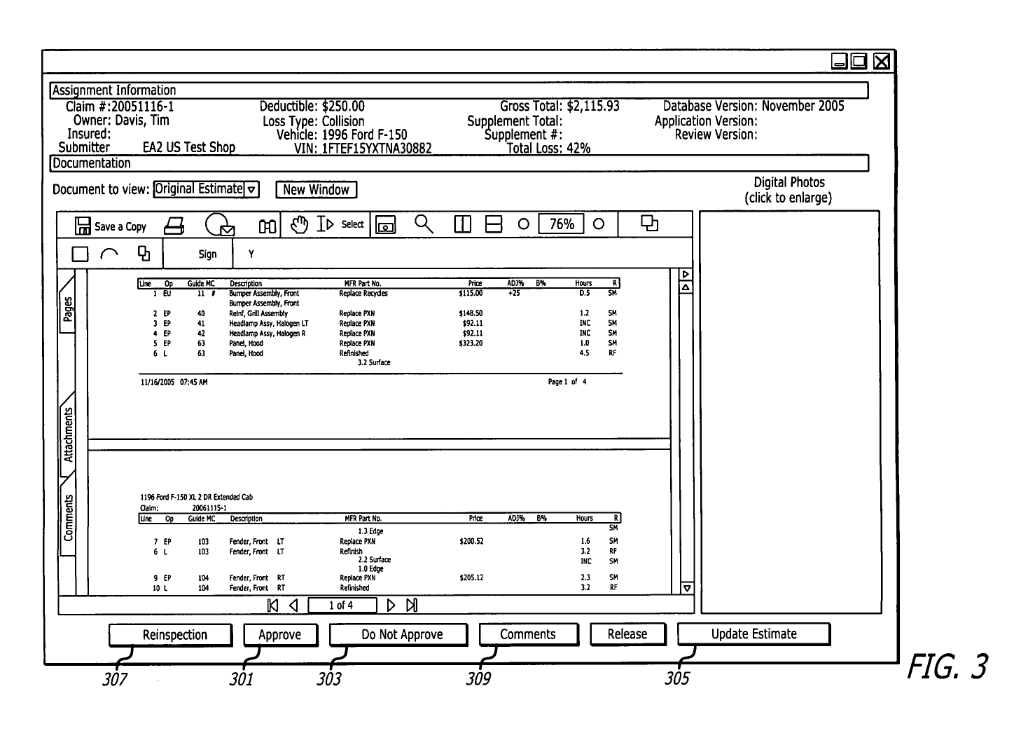

FIG. 3 shows an example of a graphical user interface 300 that may be displayed at the review station 103 at step 203. In order to approve the insurance estimate as described above the reviewer can click on an approve button 301. In order to disapprove the insurance estimate as described above the reviewer can click on a disapprove button 303. In order to change the estimate, the reviewer can click on the update estimate button 305.

In decision block 203 if the reviewer approves the insurance estimate then the estimate may be marked to indicate that it is completed. The estimator may be sent a notification that the estimate has been approved. If the estimator disagrees with the outcome he can supplement the estimate and it will be reviewed again. The notification to the estimator as well as any supplements to the estimate may be performed at the estimator station 107.

In decision block 203 if the reviewer disapproves the insurance estimate then the estimate is sent back to the estimator. The estimate may be marked to indicate that it has not been approved. The reviewer may include comments indicating the reasons why the estimate was not approved. The estimator may then make changes to the estimate without creating a supplement and perhaps may also make comments. The notification of the estimator as well as any changes to the estimate or additional comments may be performed at the estimator station 107. Once the estimator has finished making changes to the estimate they will be stored in the insurance file on the information estimate storage 101 and the insurance estimate can be sent to be reviewed again.

In decision block 203 the reviewer may also choose to make changes to the estimate (sometimes also described as updating the estimate) and proceed to step 205. In step 205 a copy of the estimate is made. In the event that there is more than one insurance estimate within the insurance file, the latest estimate will be copied. The system may mark the insurance estimate to indicate that there is an update in progress.

Once the estimate has been copied in step 205 the reviewer may make several types of changes to the estimate. For example, the review station 103 can display an electronic interface that allows the reviewer to change the parts used to repair the property. Such an interface is described, for example, in U.S. Pat. No. 5,839,112 issued Nov. 17, 1998, U.S. application Ser. No. 11/115,867 filed Apr. 26, 2005, U.S. patent application Ser. No. 10/979,926 filed Nov. 1, 2004, International Patent Application No. PCT/US2005/039032, and U.S. patent application Ser. No. 11/334,064 filed Jan. 17, 2006 which is assigned to the assignee of this application and hereby incorporated by reference.

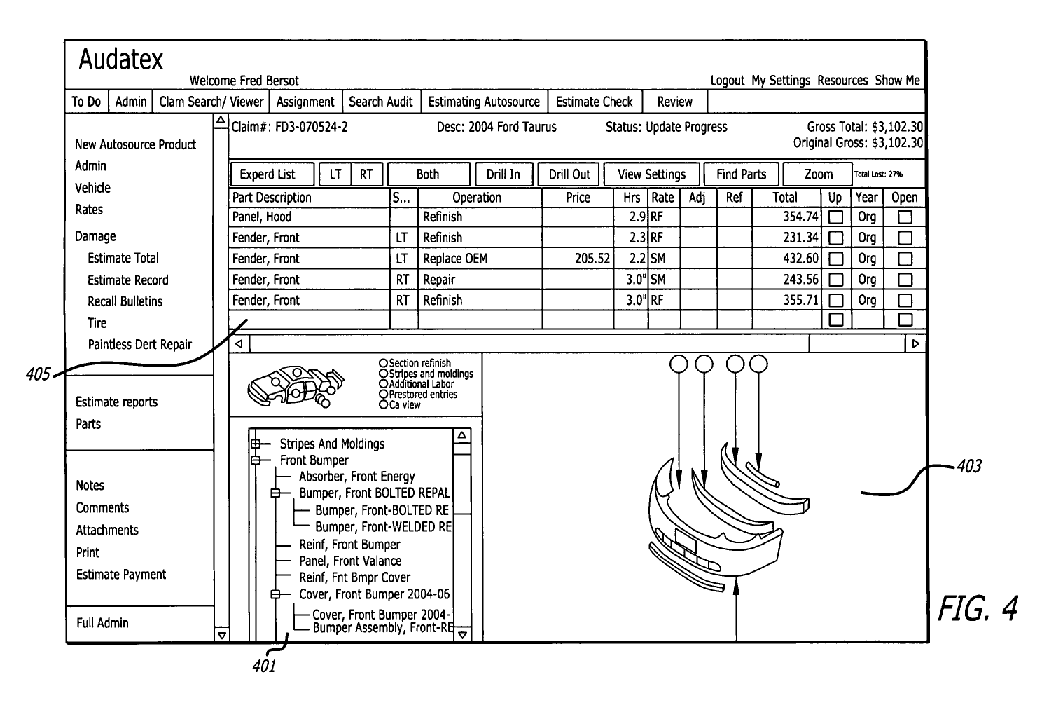

FIGS. 4, 5, and 6 show an example of a graphical user interface that allows the reviewer to change the estimate. FIG. 4 shows an overview of the insured property, in this case a car. This overview screen can display a detailed breakdown a summary of the parts and their operations used in the repair. By clicking on a particular part of the car either described textually 401 or shown graphically 403, it is possible to access information related to that part. The screen may also have a section 405 that summarizes all the operations that have been selected in the estimate.

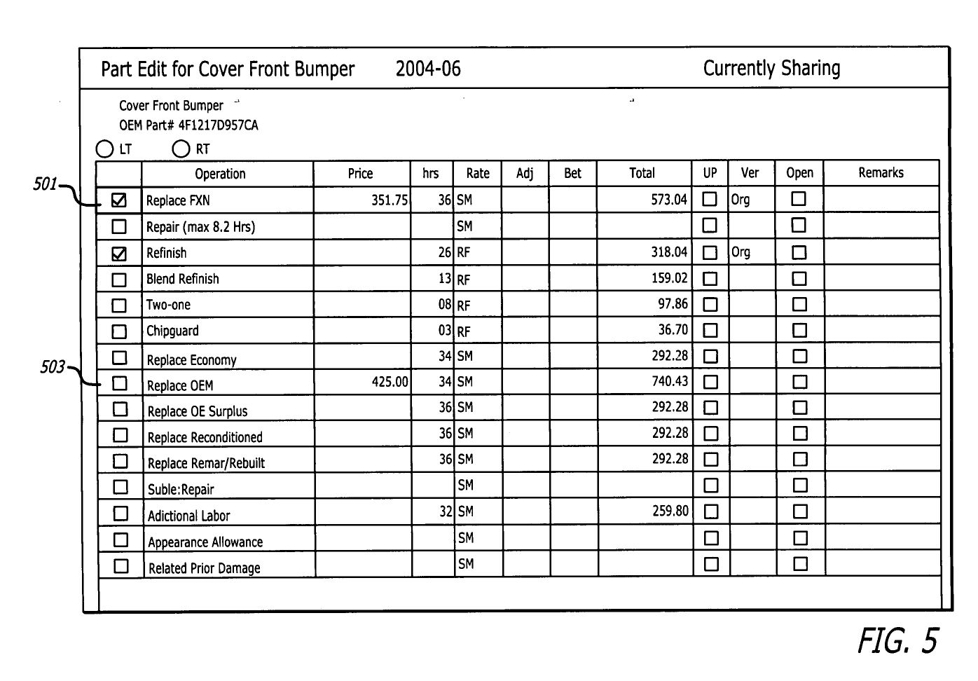

FIG. 5 shows an example of an interface that may pop up when a part is selected. It gives the various operations for repairing or replacing the part. The checked boxes 501 indicate operations that have been included in the estimate. The unchecked boxes 503 indicate additional operations. The reviewer may deselect operations included in the estimate by clicking on checked boxes 501. The reviewer may also select other operations by clicking on unchecked boxes 403.

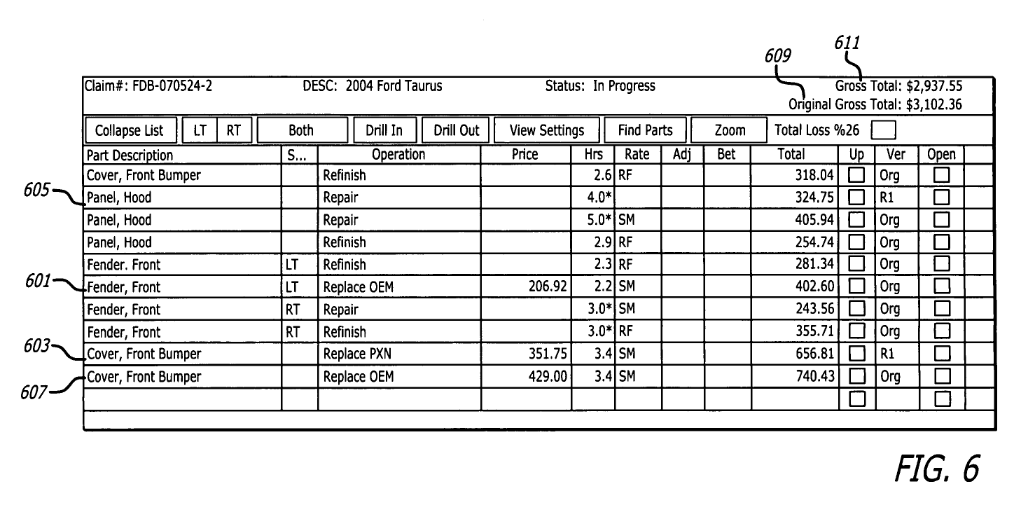

FIG. 6 is an example of a summary of the operations selected in an estimate much like described at 305 above. In this example, items from the original insurance estimate may be displayed in a normal font 601. Added parts may be shown in bold font 603. Corrected parts may be shown in with a yellow background 605 or a red strikethrough 607. The use of different colors and different fonts here make changes to the estimate easy to identify. The display may also show the original gross total 609 and the adjusted gross total 611. The adjusted gross total may be automatically updated based on the parts selected by the reviewer. For example, when a part is replaced the adjusted gross total is changed to reflect that difference in price. In another example, if a part in the original estimate is eliminated, the price of that part is subtracted from the adjusted gross total. Conversely, if an additional part is added to the estimate the adjusted gross total can be increased to reflect the added cost of that part.

After any changes are made to the estimate, the reviewer proceeds to decision block 207 where he may be given the option to approve and send for agreement or to approve and complete estimate. These choice may, for example, be displayed on the review station 103.

If in decision block 207 the reviewer chooses to approve and complete the estimate then in step 209 the original estimate will be replaced with a the changed estimate. A copy of the previous estimate will be stored in step 211. Additionally, the insurance file may be marked to indicate it has been completed, the copy of the original estimate will be marked to indicate that it has been completed with revisions and the revised estimate will be marked to indicate that a review has been completed.

If in decision block 207 the reviewer changes the estimate and chooses the option to approve and send for agreement the new estimate will also replace the original in step 209 and a copy of the original estimate will be stored in step 211.

Unlike when in decision block 207 the reviewer chooses approve and complete, when the reviewer decides to approve and send for agreement, insurance file and original estimate may both then be marked to indicate that they are pending agreement. Furthermore, a copy of the new estimate is sent to the estimator who will have the choices shown in decision block 213.

In decision block 213 the estimator can either accept or reject and modify the new estimate. If the estimator accepts the agreement then the insurance file is marked as approved and the original estimate is marked completed with revisions. If the estimator rejects the agreement insurance file is sent back to step 201 where it is again subject to approval. If this happens the insurance file and original estimate are marked to indicate that it is pending approval. Again, the estimator may approve or reject the estimate through the estimator station 107. The estimate remains in-progress and no supplement is required to update the estimate.

Overview of Reinspection Process

In some embodiments, for example at decision block 203 in FIG. 2, the reviewer can be presented the option of requesting reinspection. This option can also be presented to the reviewer in a graphical user interface. For example the graphical user interface in FIG. 3 shows that the reinspection option has been incorporated into a graphical interface and the reviewer may choose to have the estimate reinspected by clicking on the reinspection button 307.

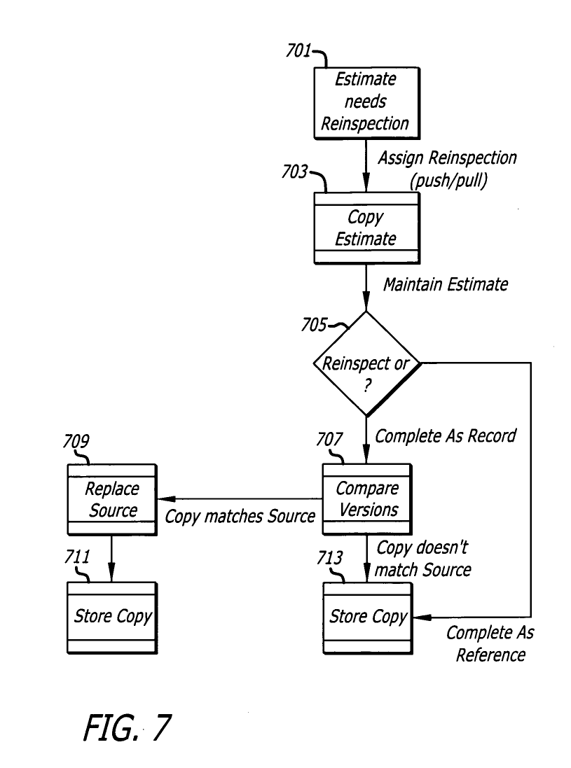

FIG. 7 illustrates one embodiment with the reinspection option. When the reviewer requests reinspection in decision block 203, this is indicated in step 701.

In step 701, the reviewer may then be given a list of available reinspectors in a push/pull process. For example, at his review station 103 the reviewer may be automatically provided with a list of available reinspectors. The list of available reinspectors may be generated automatically based on the work load of particular reinspectors as well as their abilities. The list may also be derived using the reinspectors provisioned in the office the estimate originated in. The reviewer may select from this list in order to assign the insurance file to a reinspector from the list.

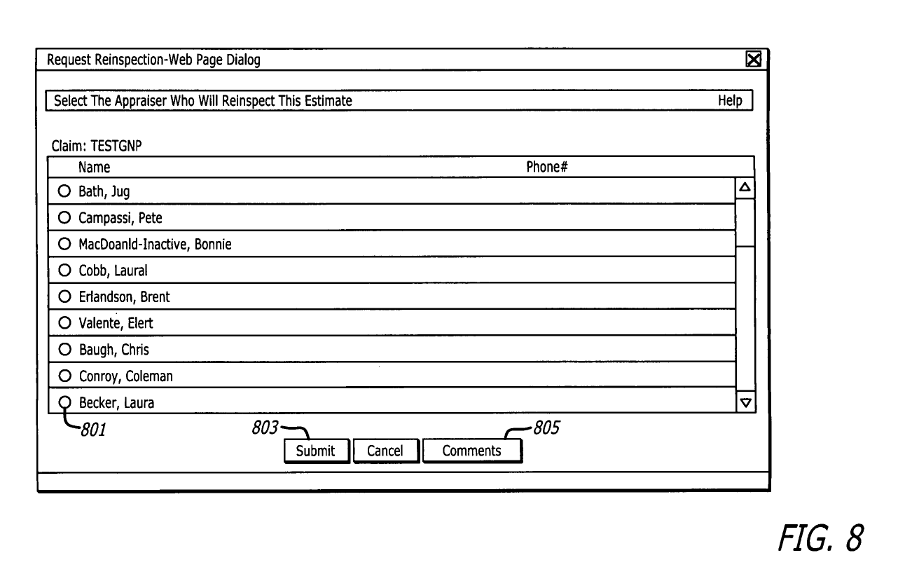

FIG. 8 shows an example of a graphical interface showing the list of available reinspectors. From this screen the reviewer may select an available reinspector by clicking on the button 801 next to the reinspector's name and then clicking on the submit button 803. Once a reinspector is assigned, step 703 may begin.

In step 703 a copy of the estimate is made. The status of the insurance file or the estimate may also be changed to indicate that it has been assigned to reinspection. The reinspector can view the insurance file at his reinspection station 105 and the status of the insurance file or the estimate can be changed to indicate that reinspection is in progress.

The reinspector may also make changes to the estimate. For example, through the reinspection station 105 the reinspector may be provided with a similar electronic interface to one provided to the reviewer as described above. The reinspector can then decide whether to complete any changes as a record or as a reference.

Decision block 705 shows that if the reinspector decides to complete changes as a record the next step is 707. In step 707 the changed estimate is compared to the original estimate.

If the comparison 707 reveals that changed estimate and the original estimate match then in step 709 the new estimate replaces the old estimate. The status of the insurance file can be changed to indicate that it is completed. The copy of the estimate and the original estimate may have their status changed to indicate that reinspection has been completed. Then in step 711 copies of the original and changed estimate are stored.

If the comparison 707 reveals that changed estimate does not match the original estimate (or source) then in step 713 the new estimate is stored. The insurance file status and original estimate status may be kept the same but the new estimate status can be marked to indicate that the reinspection was completed.

Communication Systems

In some embodiments, the system may also include an integrated system that allows the reviewer, reinspector, and estimator to communicate regarding insurance files. For example, the reviewer, reinspector, or estimator may be able to write comments that are stored in the insurance file. These comments could then be read by others who open the insurance file.

FIGS. 3 and 8 show examples of graphical user interfaces that incorporate the comment system of communications. In FIG. 3, a reviewer (or reinspector) may choose to leave a comment by clicking on the comment button 309. FIG. 8 shows a graphical user interface of an embodiment where the reviewer can leave a comment when selecting a reinspector. In this example the reviewer can submit a comment by clicking on the comment button 805.

It may be preferable that the comments left by a reviewer or reinspector be kept private and not be made available to everyone who opens the insurance file. For example, it may be that some comments may need to be kept hidden from the estimator. Therefore it is contemplated that comments may be marked private from some parties with general access to the insurance file.

Approve and Complete Process

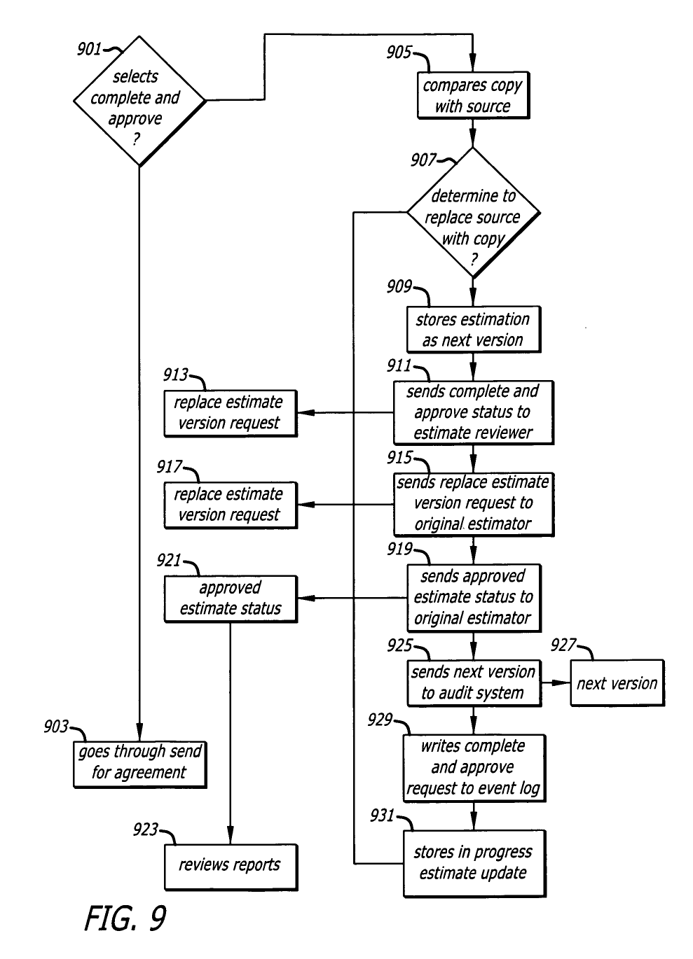

As discussed in one embodiment above, the reviewer may choose to approve and complete his changed estimate. FIG. 9 is a flowchart that illustrates the details of one embodiment of the approve and complete process. As in decision block 207 above, decision block 901 allows the reviewer to choose to complete and approve the changed estimate. If the reviewer does not choose this option then changed estimate will be treated as sent for agreement in step 903.

At decision block 901, if the reviewer chooses to approve and complete then it moves to step 905. In step 905 the system can compare the changed estimate (copy) of the estimate with the original estimate (source). Optionally, rather than comparing the versions other methods can be used to ensure that updates are performed on the last version.

Decision block 903 shows that if the system indicates that the two are identical then the system proceeds to step 909 which stores the estimate as the next version. Next in step 911 the system sends a status message to the reviewer that the insurance file is complete and approved. The complete and approved status is displayed for the reviewer in step 913. This may be displayed, for example, at a review station 103.

In addition, the system continues to step 915 and sends a replace estimate version request to the estimator. This status change can be received in step 917. For example it can be displayed at an estimator station 107.

After step 915 in step 919 the system may also send approved estimate status to the estimator. This message can then be displayed in step 921, for example at a estimator station 107. The estimator may the review the reports at step 923.

It is also contemplated that in step 925 the system may send a version of the estimate to an audit system. This may be displayed to the auditor in step 927. Furthermore the system may then record a complete and approve request to the event log in step 929.

At decision block 903, if the source and copy are not identical then the system proceeds to step 931 and stores the in progress estimate as an update. Optionally, rather than comparing the versions other methods can be used to ensure that updates are performed on the last version.

Approve and Send for Agreement Process

As discussed above, several embodiments are contemplated where the reviewer may send for agreement any changes he makes to the estimate. For example, such options appear at decision blocks 207 or 901 in the figures above.

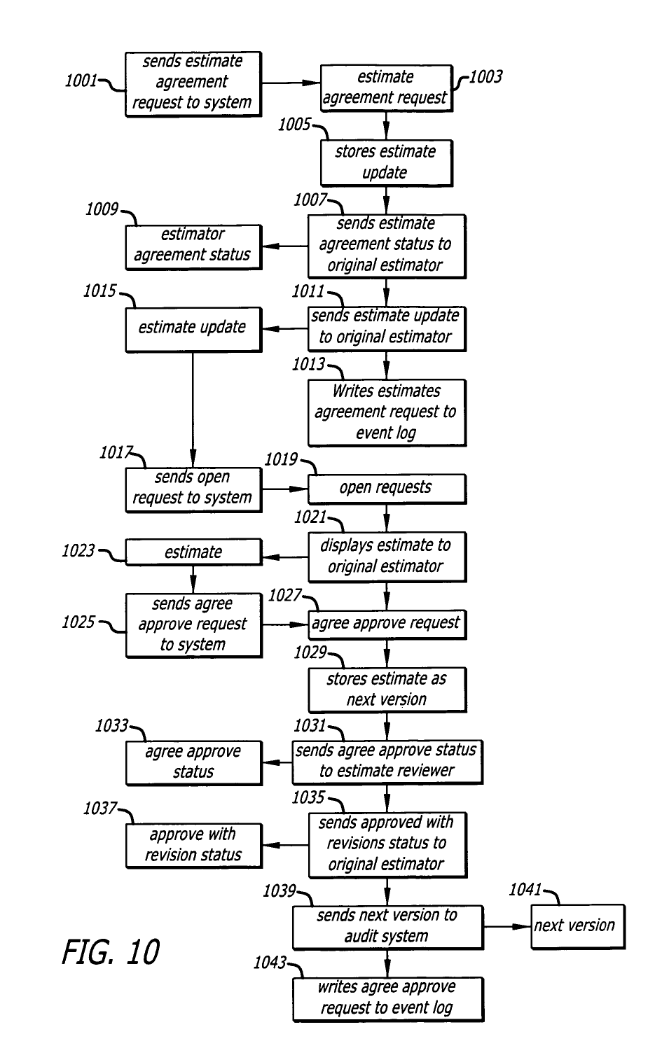

FIG. 10 is a flow chart illustrating one embodiment of sending for agreement. Once the reviewer sends an estimate agreement request and updated estimate to the system in step 1001, the system processes the request in step 1003. The system then stores the estimate update in step 1005 and sends an estimate agreement status indicator to the estimator in step 1007. The estimate agreement status is displayed to the estimator in step 1009, for example through the estimator station 107.

After step 1007 the system also sends an estimate update to the estimator in step 1011 and writes estimate agreement request to an event log in step 1013. When the estimate update is displayed to the estimator in step 1015 the estimator can then send a request in step 1017 to the system to allow him to open the estimate. The display of the estimate 1015 and sending the estimate 1017 may be done, for example, at a estimator station 107.

When the open request is sent to the system in step 1017, the system will receive the request in step 1019 and display the estimate to the estimator in step 1021. In step 1023 the estimator sees the estimate, for example on a estimator station 107. The estimator can then send an agree-approve request to the system in step 1025. This agree-approve request is received by the system at step 1027 and causes the system in step 1029 to store the estimate version as the next version. The system then sends agreement approve status to the reviewer in step 1031 and this status is displayed in step 1033. This can be done, for example, by way of the review station 103.

After step 1031, in step 1035 the system can also send an approved with revisions status to the estimator. In step 1037 this status can be displayed to the estimator, for example at the estimator station.

After step 1035 the system can send the next version to an audit system in step 1039. The next version is then displayed to the audit system in step 1041. The system can then also write a agree-approve request to the event log in step 1043.

Station Description

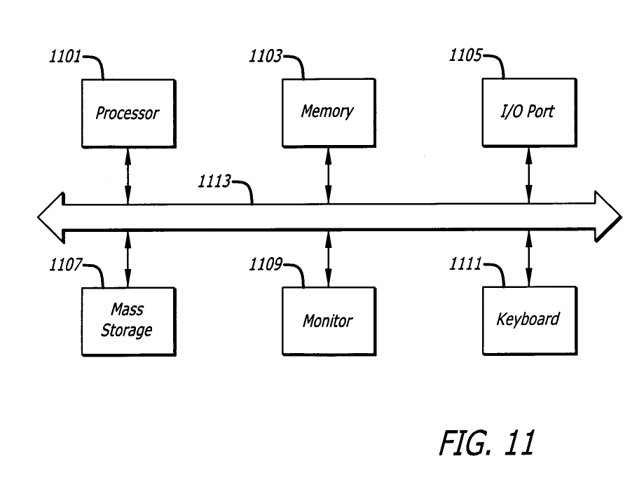

FIG. 11 shows an embodiment of a station for entering and receiving data from the system. This embodiment can be applied the review station 103, reinspection station 105, or estimator station 107. The station includes a processor 1101 connected to one or more memory devices 1103. The memory device 1103 may include both volatile and non-volatile memory such as read only memory (ROM) or random access memory (RAM). The processor 1101 is capable of operating software programs in accordance with instructions and data stored within the memory device 1103.

The processor 1101 may be coupled to a communication port 1105, a mass storage device 1107, a monitor 1109 and a keyboard 1111 through bus 1113. The processor 1101 may also be coupled to a computer mouse, a touch screen, a microphone, a speaker, an optical code reader (not shown). The communication port 1105 may include an ETHERNET interface that allows data to be transmitted and received in TCP/IP format, although it is to be understood that there may be other types of communication ports. The system bus 1113 may be a PCI or other conventional computer bus. The mass storage device 1107 may include one or more disk drives such as magnetic or optical drives. The mass storage device 1107 may also contain software that is operated by the processor 1101.

Without limiting the scope of the invention, the term computer readable medium may include the memory device 1103 and/or the mass storage device 1107. The computer readable medium may contain software programs in binary form that can be read and interpreted by the computer. In addition to the memory device 1103 and/or mass storage device 1107, computer readable medium may also include a diskette, a compact disc, an integrated circuit, a cartridge, or even a remote communication of the software program.

What is claimed is:

1. A system for reviewing insurance estimates, comprising:
an insurance estimate storage system and a review station that allows a reviewer to review the insurance estimates.
